(19) United States
(12) Patent Application Publication
(10) Pub. No.: US 2003/0014241 A1
(43) Pub. Date: Jan. 16, 2003

(54) Method of and apparatus for converting an audio signal between data compression formats

(76) Inventors: Gavin Robert Ferris, London (GB); Michael Vincent Woodward, London (GB)

Correspondence Address: Richard C Woodbridge, Woodbridge & Associates, PO Box 592, Princeton, NJ, 08542-0592, US

(21) Appl. No.: 10/204,360

(22) PCT Filed: Feb. 19, 2001
(86) PCT No.: PCT/GB01/00690

(30) Foreign Application Priority Data
Feb. 18, 2000 (GB) 0003954.5

(51) Int. Cl. G10L 19/00

(52) U.S. Cl. 704/200.1; 704/230

(57) ABSTRACT

Useful subband information which is present in a first audio signal (for example, MPEG 1 Layer II) is discarded in the conventional approach of format conversion, only to be regenerated when encoding to the target format (for example, MPEG 1 Layer III). Instead, in the present invention, this useful subband information is re-used directly or indirectly in order to eliminate the conventional requirement to fully decode to PCM and then encode again.

### FIELD OF THE INVENTION

This invention relates to a method of and apparatus for converting an audio signal from one data compression format to another data compression format. It may for example be used to convert MPEG 1 Layer II audio signals to MPEG 1 Layer III audio signals.

### DESCRIPTION OF THE PRIOR ART

Converting an audio signal in one data compression format to a target data compression format has in the past been done as a two-stage process. The first stage is to de-compress the audio signal in a decoder in order to generate an intermediary signal. This intermediary signal is in essence fully decoded raw data, typically in PCM format. In the second stage, this raw audio signal is then re-compressed in the target format in an encoder. Hence, one solution to the problem of converting MPEG 1 Layer II audio signals to MPEG 1 Layer III audio signals would be to decode the source signal using an MPEG 1 Layer II decoder system; this is represented schematically in FIG. 1. The resultant PCM signal would then be encoded using the MPEG 1 Layer III encoder represented schematically in FIG. 2. The encoding and decoding processes are discussed more fully in “ISO-MPEG-1 Audio: A Generic Standard for Coding of High-Quality Digital Audio”, Brandenburg K-H., Stoll G., J. Audio Eng. Soc., 42, pp780-792, October 1994.

There are many disadvantages to the conventional approach of converting an audio signal between data compression formats. First, it requires extensive computer CPU resources (particularly for the numerically intensive operations in the encoder) malting it impractical to use this approach in real-time in a software only system. Secondly, it requires expensive components (such as a DSP chip to perform FFTs in the encoder) for a hardware implementation. Finally, the resultant audio signal in the target format will be of a lower quality than the input signal in the source format because of the extra data reduction techniques applied in the encoder (e.g. psycho-acoustic compression) and the noise shaping or filtering normally applied to the input audio signal.

Whilst this invention relates to converting audio signals between different audio compression formats, reference may also be made to the problem of converting a video signal between different formats. EP 0637893 discloses the general principle of converting a source video signal from one video format to a different video format by re-using information in the source video signal. This eliminates the need to completely decode from the first format and then re-encode into the different format. EP 0637893 is however of only background relevance to this invention since (i) it does not relate to the audio domain and (ii) is in particular wholly silent on re-using subband data in the source signal.

Finally, the relevant prior art should be compared and contrasted with techniques for converting a signal from one bit rate to another but retaining the same compression format. The present invention is not concerned with such techniques.

### SUMMARY OF THE PRESENT INVENTION

In accordance with a first aspect of the present invention, there is a method of converting a first audio signal in a first data compression format, in which a frame includes subband data, to a second audio signal in a second data compression format, characterised in that:

the subband data in the first audio signal is used directly or indirectly to construct the second audio signal without the first audio signal having to be fully decoded prior to encoding in the second data compression format.

Hence the present invention is predicated on the insight that useful subband information which is present in the first audio signal (for example, MPEG 1 Layer II) is in effect discarded in the conventional approach of decoding to raw, PCM format data, only to be re-generated when encoding to the target format (for example, MPEG 1 Layer III). Instead, in the present invention, this useful subband information is re-used directly or indirectly in order to eliminate the conventional requirement to fully decode to PCM and then encode again.

More specifically, the subband data present in the first audio signal may be the 32 subband co-efficients that are output from the subband analysis that the original encoder performed. The subband analysis generates the 32 subband representations of the input audio stream in, for example, a MPEG 1 Layer II encoder. Conventionally, if one were to convert a signal in MPEG 1 Layer II format by decoding that signal to PCM and then encoding it in MPEG 1 Layer III, the subband co-efficients present in an MPEG 1 Layer II frame would be stripped out by the subband synthesis in a MPEG 1 Layer II decoder, only to be re-generated again in the subband analysis in the MPEG 1 Layer III encoder. The present invention therefore contemplates, in one example, re-using (as opposed to re-generating the subband co-efficients to remove the need for subband synthesis in the decoder and the subband analysis in the encoder. This has been found to significantly reduce CPU loading.

In one implementation, additional data, which is included in or derived/inferred from a frame or frames, is used to enable the second audio signal to be constructed (at least in part). For example, this additional data may include the change in scale factors (this data is not present in the frame, but derived from it) or the related change in the subband co-efficients in the first audio signal; this can be used to estimate a psycho acoustic entropy of the second audio signal which in turn can be used to determine the window switching for the second audio signal. Conventionally, psycho acoustic entropy is calculated using a FFT and other costly transforms in the psycho-acoustic model (PAM) in an encoder. Whilst the PAM in an encoder has an additional use (determining the signal to mask ratio for each band), the present invention can eliminate the psycho acoustic entropy calculation conventionally performed by the PAM and therefore go at least half way to removing the need for a costly FFT and the other PAM transforms entirely.

In a preferred implementation, the additional data can additionally (or alternatively) comprise the signal to mask ratio (‘SMR’) applied in the first audio signal, as inferred from the scale factors or scale factor selector information (‘SCFSI’) present in the first audio signal. Hence, the signal to mask ratio used in the MPEG 1 Layer II signal (for example) can be inferred from its scale factors (or SCFSI); from that, a reasonably reliable estimate of the signal to mask ratio which needs to be used in a MPEG 1 Layer III encoded signal, can be derived. Essentially, SMR has the same meaning in both MPEG 1 Layer II and III. They are however applied slightly differently due to differences in the layer organisation.

Hence, the two conventional reasons for using a PAM in an encoder (i.e. (i) estimating the psycho acoustic entropy in order to determine window switching; and (ii) determining the signal to mask ratio for each band) are fully satisfied in a preferred implementation of the invention without using a PAM at all. Instead, data present in the original audio signal or inferred/derived from the original audio signal is used to yield the required window switching and signal to mask ratio information.

Conventionally, there is a distortion control loop which fits the sampled data to the available space and controls the quantisation noise introduced. This is performed in the MPEG standard via nested loops, although other methods are possible. A preferred implementation of the invention reduces the number of loop iterations needed by using a lookup table to determine the quantisation step size. The lookup table is based on the gain or SMR determined from the Layer II frame.

The present invention applies equally to the conversion between many other audio formats, including for example, MPEG 1 Layer II to MPEG 1 or 2 Layer III, MPEG 2 Layer II to MPEG 1 or 2 Layer III, MPEG 1 Layer III to MPEG 1 or 2 Layer II and between other non-MPEG, audio compression formats. However, real-time efficient software based conversion of MPEG 1 (or 2) Layer II signals to MPEG 1 (or 2) Layer III signals is the most commercially important application. This is particularly useful in, for example, a DAB (Digital Audio Broadcast) receiver, since it allows a user to transparently and in real time record DAB broadcast material in MP3 format. DAB is a digital radio broadcast technology that is just starting to become commercially available within Europe. DAB broadcasts MPEG 1 (or MPEG 2) Layer II frames. MP3 is currently the recording format of choice for PC and handheld digital audio playback, particularly portable machines such as the Diamond Rio. The efficiency of the present implementations means that CPU resources need not be fully devoted to the format conversion process. That is particularly important in most consumer electronics products, where the CPU must be available continuously for many other tasks. Further information on MPEG 1/2 Layer II and MPEG 1/2 Layer III can be found in the pertinent standards (i) ISO 11172-3, Information technology—Coding of moving pictures and associated audio for digital storage media at up to about 1.5 Mbit/s—part 3: audio, 1993 and (ii) ISO 13818-3, Information technology generic coding of moving pictures and associated audio information—Part 3. Audio, 1996.

The above methods can be implemented in a DSP, FPGA or other chip level devices. In other aspects of the present invention, there is an apparatus programmed to perform the above methods and software to perform the above methods.

### BRIEF DESCRIPTION OF THE DRAWINGS

The invention will be described with reference to the accompanying drawings, in which:

FIG. 1 is a schematic of a prior art MPEG 1 Layer II decoder;

FIG. 2 is a schematic of a prior art MPEG 1 Layer III encoder; and

FIG. 3 is a schematic of a MPEG 1 Layer II to MPEG 1 Layer III converter; this is an implementation of the present invention.

### DETAILED DESCRIPTION

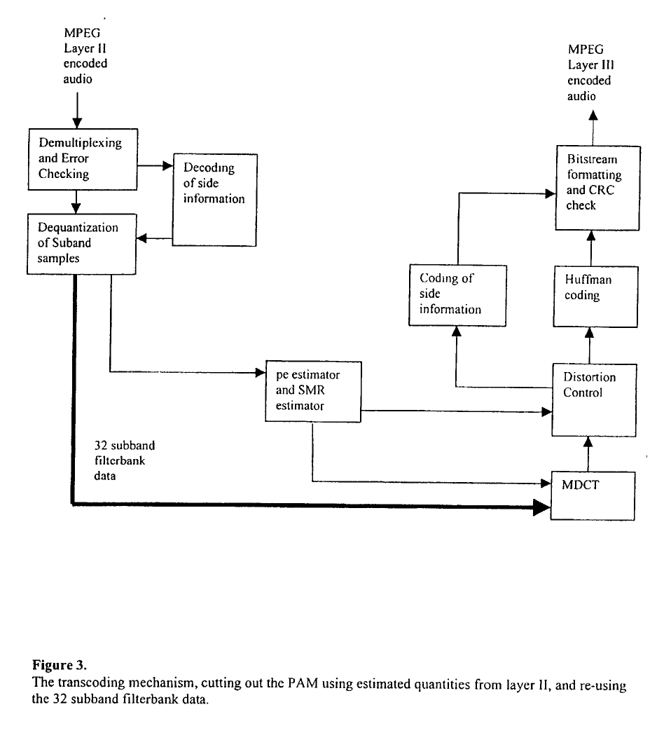

The present invention will now be described in relation to FIG. 3. Note that FIG. 3 shows a ‘transcoder’ for the real-time, software based conversion from MPEG 1 layer II to MPEG 1 Layer III: this is an example embodiment and should not be taken to limit the scope of the invention. Note also that the term ‘transcoder’ is sometimes used in relation to a device which can change the bit rate of a signal but retain its compression format. As explained earlier, the present invention does not relate to this art, but instead to devices which can change the compression format of a signal. Bit rate alteration is not an excluded capability of a transcoder covered by this invention however, as it may be an inevitable consequence of changing the compression format of a signal.

Over the last few years MP3 (MPEG 1 Layer III) technology has become very widely adopted. The Internet has many sites devoted to music in MP3 format (such as MP3.com), and MP3 players have become widely available on the high street. Layer II and Layer III are based on the same core ideas, but Layer III adds greater sophistication in order to achieve greater audio compression. The principle differences are:

1. use of a different or modified psycho-acoustic model

2. use of window switching to reduce the effects of pre-echo

3. non-linear quantisation

4. Huffman coding.

The PAM models the human auditory system (HAS) and removes sounds that the HAS cannot detect. It does this both in the time and frequency domain, which involves expensive numerical transformations. One of the outputs of the PAM is the psycho acoustic entropy (pe). This quantity is used to indicate sudden changes in the music (often called percussive attacks). Percussive attacks can lead to audible artefacts known as pre-echoes. Layer III reduces pre-echoes by using a window switching technique based on the psycho acoustic entropy.

The non-linear quantisation is a very expensive calculation process. The process suggested by the standard (ISO 111 72-3, Information technology—Coding of moving pictures and associated audio for digital storage media at up to about 1.5 Mbit/s—part 3: audio, 1993) starts from an initial value and then gradually works towards the appropriate quantisation step size.

As explained above and below, there are a number of numerically intensive operations that must be performed on the data during encoding, as shown in the prior art FIG. 2 schematic.

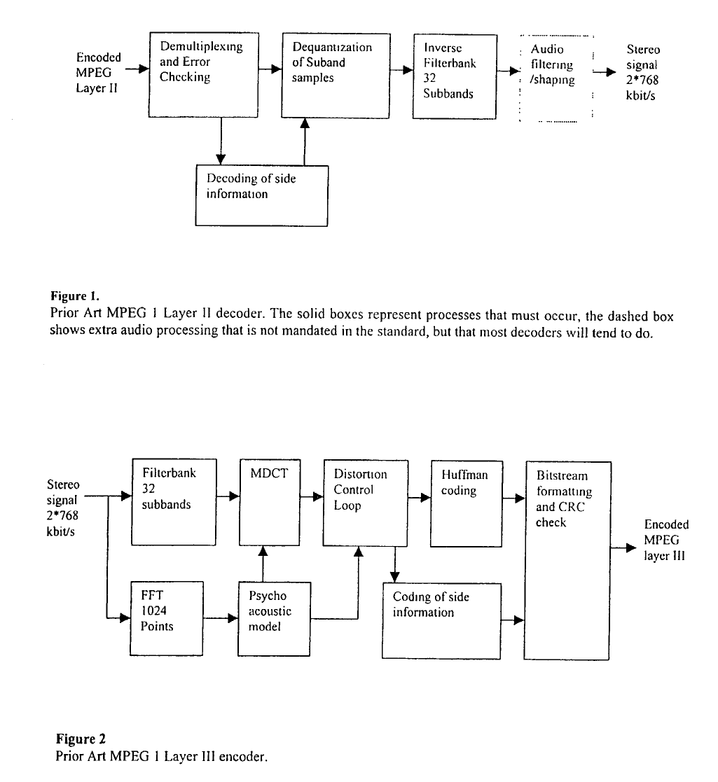

The decoding process (shown in the prior art FIG. 1 schematic), taking data in MPEG format and converting it back to PCM, does not involve a PAM and is a considerably cheaper operation. As explained above, this entails decoding the MPEG Layer II frames. Audio filtering/shaping is not mandated in the MPEG standards, but is applied by most decoders in order to improve the perception of the decoded audio. For data conversion purposes, this extra processing is unwanted as it distorts the original data

The illustrated implementation is based on the application of the following key ideas:

1. Using the subband data from MPEG Layer II as the subband data for MPEG Layer III. Although the algorithm for encoding the subband data is identical in Layers II and III, the usage is different enough between the two layers to make this re-use of the subband data non-obvious. By re-using the subband data, significant savings in the CPU loading are possible.

2. The Layer II data has already been through a PAM. Although this is not the same as the PAM used for Layer III, it is very similar. We can then use the change in the scale factors in the Layer II subband data to estimate a psycho acoustic entropy. This is then used to determine the window switching.

3. From the data in the Layer II frame (or derived from it) it is possible to make a good estimate of the Layer III signal to mask ratio (SMR). From this quantity a good estimate of the quantiser step size may be calculated. This results in significant CPU savings.

At this point we have removed the need for the PAM and for the filterbanks.

Returning now to FIG. 3, the initial stages of the processing are well known, the MPEG frame is demultiplexed and the subband data is retrieved from the frame and dequantised. At this point we stop decoding the frame and we do not produce any PCM data. The outputs we take are the scale factors and the 32 subband co-efficients. From the change in the scale factors we can calculate a pe equivalent. Using the change in the scale factors is the optimal approach to calculating a pe equivalent; other less satisfactory ways (which are also within the scope of the present invention) include (a) using the change in the subband data directly or (b) multiplying the scale factors by the subband data to obtain a de-normalised quantity and then using the change in the de-normalised quantity to generate the pe equivalent. The signal to mask ratio (SMR) is calculated from the scale factors. Gain figures can be calculated from the scale factors.

The subband co-efficients are then passed directly into the MDCT (Modified Discrete Cosine Transform), which produces data in 576 spectral line blocks. The subband data must be read in the correct format. The pe is used to determine the appropriate window (e.g. short, long, etc.) to control pre-echoes.

The Distortion Control block uses the MDCT data and the SMR. The SMR is used to find an accurate initial value for the quantiser step size, so substantially reducing the CPU requirements. This block quantises the data to fit into the allowed number of bytes and controls the distortion introduced by this process so that it does not exceed the allowed distortion levels.

The data is then further compressed by being passed through a Huffman coder, and the resultant data is then formatted to the standard MPEG layer III format.

The present invention is commercially implemented in the Wavefinder DAB receiver from Psion Infomedia Limited of London, United Kingdom as a real-time, pure software implementation.

### Acronyms

| | |
|---|---|
| DAB | Digital Audio Broadcasting |
| DSP | Digital Signal Processing |
| FPGA | Floating Point Gate Array |
| HAS | Human Auditory System |
| MDCT | Modified Discrete Cosine Transform |
| MP3 | A poorly defined acronym that is usually taken to mean |
| | MPEG 1 Layer III. |
| MPEG | Moving Pictures Expert Group of the ISO. This acronym is |
| | used here to refer to the standards issued by the ISO. |
| MPEG 1 | An audio coding technology. |
| MPEG 2 | An audio coding technology used for low bit rate channels |
| | (e.g. speech). The algorithms used are the same as MPEG |
| | 1, but some of the parameters are different. |
| PAM | Psycho Acoustic Model |
| PCM | Pulse Code Modulation. A very simple system of quantising |
| | an audio signal. This is the method used on CDs. |
| pe | Psycho acoustic entropy. One of the outputs of the PAM |
| | that decides the window needed in MPEG Layer III. |
| SCFSI | Scale Factor Selector Information. Used in MPEG encoding |
| | to give enhanced compression. |
| SMR | Signal to Mask Ratio. The amount by which the signal |
| | exceeds the noise threshold for that particular band. |

1. A method of converting a first audio signal in a first data compression format, in which a frame includes subband data, to a second audio signal in a second data compression format, characterised in that:
the subband data in the first audio signal is used directly or indirectly to construct the second audio signal without the first audio signal having to be fully decoded prior to encoding in the second data compression format.

2. The method of claim 1 in which the subband data is the 32 subband analysis co-efficients that are output from a filterbank or transform which generates 32 subband representations of an input audio stream.

3. The method of claim 2 in which additional data, which is included in or is derivable or inferable from the frame or several frames, is used directly or indirectly to construct the second audio signal without the first audio signal having to be fully decoded prior to encoding in the second data compression format.

4. The method of claim 3 in which the additional data is the change in scale factors or the related change in the subband co-efficients in the first audio signal and that additional data is used to estimate a psycho acoustic entropy for the second signal which in turn is used to determine window switching for the second audio signal.

5. The method of claim 3 in which the additional data is the signal to mask ratio applied in the first audio signal, as inferred from the scale factors used in the first audio signal, which is used to estimate the signal to mask ratio required for the second audio signal.

6. The method of claim 5 in which the estimated signal to mask ratio is used to find the initial value for a quantiser step size.

7. The method of claim 6 in which a look-up table is used to determine the initial value for the quantiser step size.

8. The method of claim 1 in which the first signal is in MPEG 1 Layer II format and the second signal is in MPEG 1 or 2 Layer III.

9. The method of claim 1 in which the first signal is in MPEG 2 Layer II format and the second signal is in MPEG 1 or 2 Layer III.

10. The method of claim 1 in which the first signal is in MPEG 1 Layer III format and the second signal is in MPEG 1 or 2 Layer II.

11. The method of claim 1 in which the first signal is in MPEG 2 Layer III format and the second signal is in MPEG 1 or 2 Layer II.

12. The method of any preceding claim which is implemented as a real-time, software implementation.

13. Apparatus for converting a first audio signal in a first data compression format, in which a frame includes subband data, to a second signal in a second data compression format, in which the apparatus is programmed to perform any of the methods claimed in any preceding claims 1-12.

14. The apparatus of claim 13, being a DSP chip, FPGA chip, or other chip level device.

15. Computer software for performing any of the methods claimed in any preceding claims 1-12.

16. The computer software of claim 15, capable of performing in real time.
